(19) United States
(12) Patent Application Publication
(10) Pub. No.: US 2005/0193426 A1
(43) Pub. Date: Sep. 1, 2005

(54) System and method to control fingerprint processing in a media network

(76) Inventor: Raja Neogi, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/788,838

(22) Filed: Feb. 27, 2004

(51) Int. Cl. H04N 7/00; H04N 7/16

(52) U.S. Cl. 725/138

(57) ABSTRACT

A system and method for controlling fingerprint processing in a media network via an efficient protocol. The method includes determining, at a headend node, terminal node characteristics of a media network. Then, based on the determined terminal node characteristics, an algorithm and one or more control parameters are selected for processing a fingerprint. The selected algorithm and one or more control parameters are downloaded to a terminal node. The terminal node uses the algorithm to extract a fingerprint and then sends it back to the headend node for verification.

### BACKGROUND

With the rapid growth of the networking infrastructure, the volume of digital media traffic in these networks has climbed dramatically. More and more digital content is produced and consumed in home networks, broadcast networks, video-on-demand (VOD) networks, enterprise networks, Internet protocol (IP) networks and so forth. With the increased volume of digital media traffic in these networks, the digital piracy rate has also increased. Thus, many networks today require some type of copyright protection mechanism in their storage networks to protect against digital piracy.

Fingerprinting is one such copyright protection mechanism used today by networks to protect against digital media piracy (both video and audio). In general, fingerprinting entails capturing special characteristics that uniquely identify an object amongst others. Because fingerprinting can uniquely identify an object amongst others, it can be used for identification and/or authentication purposes. Copyright infringement is established by analyzing anomalies at various nodes of a media distrubution tree. In a similar manner, audio/visual quality or content integrity at end nodes of the media distrubution tree can be decipered through mismatch analysis. Being able to control fingerprint generation and verification in networks is crucial since fingerprinting is applied to specific portions of the content with rich audio/visual characteristics.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of a media distribution network environment in which some embodiments of the present invention may operate;

FIG. 2 illustrates one embodiment of a fingerprint control protocol;

FIG. 3 illustrates one embodiment of the inter-workings of the fingerprint control protocol;

FIG. 4 is a flow diagram of one embodiment of a process for operating the fingerprint control protocol;

FIG. 5 illustrates one embodiment of a fingerprint control block and a fingerprint block in which some embodiments of the present invention may utilize; and

FIG. 6 is a flow diagram of one embodiment of a process for the operation of consumer/terminal node(s).

### DESCRIPTION OF EMBODIMENTS

A method and system for controlling fingerprint processing in a media network via an efficient protocol are described. The fingerprint type may incude, but is not limited to, video and audio fingerprints. In an embodiment of the present invention, terminal node characteristics of the media network are snooped to select an optimal algorithm and set of operational control parameters for fingerprint processing (e.g., generation and verification) in the media network. The selected algorithm and set of operational control parameters are downloaded via a fingerprint control protocol for the fingerprint processing to start. In an embodiment of the invention, the packetization of the fingerprint control protocol involves packing data into private MPEG elementary streams that are transported via the protocol over the media network to consumer/terminal nodes. The backchannel of the media network utilizes an idential protocol layout, but with fewer elementary streams (ES). The exact number of the elementary steams utilized depends, at least partially, on resource contraints in the media network. In the following description, for purposes of explanation, numerous specific details are set forth. It will be apparent, however, to one skilled in the art that embodiments of the invention can be practiced without these specific details.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like. Other types of mechanisms may be added or substituted for those described as new types of mechanisms are developed and according to the particular application for the invention.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

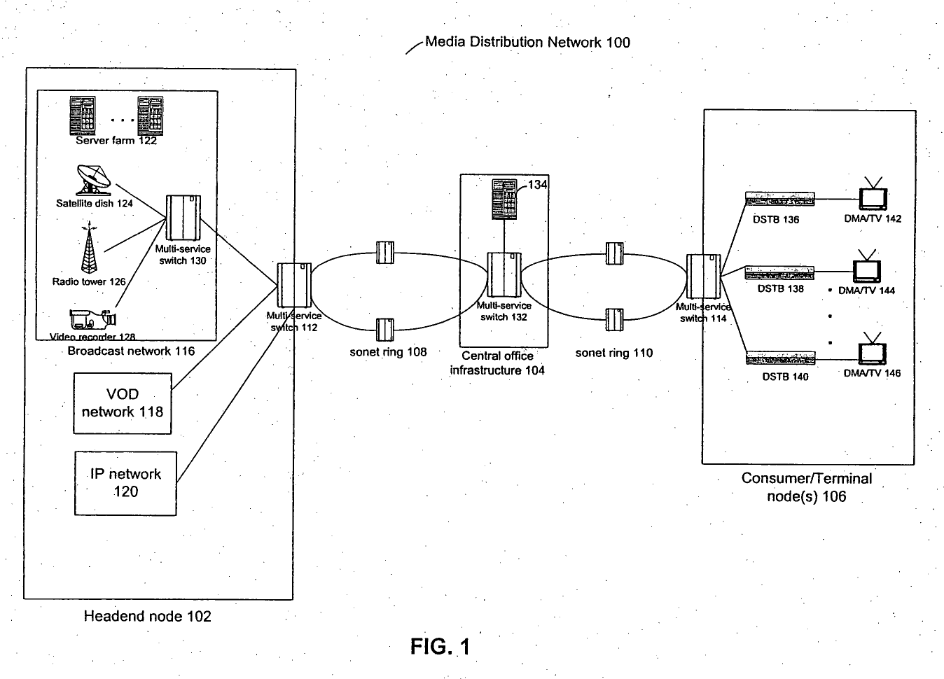

FIG. 1 illustrates one embodiment of a media distribution network 100 in which some embodiments of the present invention may operate. Referring to FIG. 1, media distribution network 100 includes, but is not necessarily limited to, a headend node 102, a central office infrastructure 104 and one or more consumer/terminal nodes 106. Headend node 102 is connected to central office infrastructure 104 via a synchronous optical network (SONET) ring 108. Central office infrastructure 104 is connected to consumer/terminal node(s) 106 via SONET ring 110. Each of these components is described below in more detail.

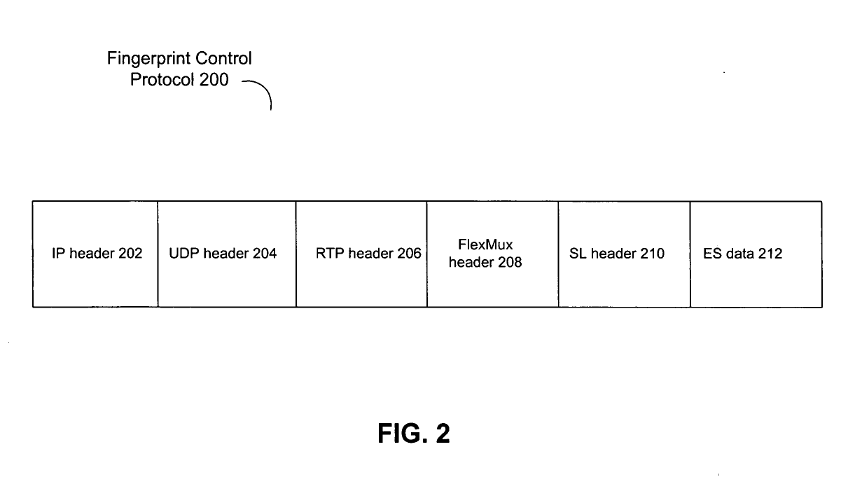

As described above, the present invention is a method and system for controlling fingerprint processing in media distribution network 100 via an efficient protocol. In an embodiment of the invention, media content from headend node 102 is distributed to digital set-top boxes inside consumer homes (i.e., consumer/terminal node(s) 106). Consumer/terminal node(s) 106 characteristics are snooped by headend node 102 to select an optimal algorithm and set of operational control parameters for fingerprint processing (e.g., generation and verification) in media distribution network 100. The selected algorithm and set of operational control parameters are downloaded via a fingerprint control protocol stored in central office infrastructure 104 for the fingerprint processing to start. The fingerprint control protocol is downloaded to both headend node 102 and consumer/terminal node(s) 106. In an embodiment of the invention, the packetization of the fingerprint control protocol involves packing data into private MPEG elementary streams that are transported via the protocol over media distribution network 100 to consumer/terminal node(s) 106. An embodiment of the fingerprint control protocol is described below in more detail with reference to FIG. 2.

Headend node 102 may include, but is not necessarily limited to, a broadcast network 116, a video-on-demand (VOD) network 118, an Internet protocol (IP) network 120 and a multi-service switch 112. Multi-service switch 112 connects to SONET ring 108. Broadcast network 116 may include, but is not necessarily limited to, a server farm 122, a satellite dish 124, a radio tower 126, a video recorder 128 and a multi-service switch 130.

Central office infrastructure 104 may include, but is not necessarily limited to, a multi-service switch 132 and one or more servers 134. In an embodiment, one or more servers 134 store the fingerprint control protocol(s) of the present invention. Multi-service switch 132 connects to SONET ring 108 and SONET ring 110. In an embodiment of the invention, central office infrastructure 104 does point-to-point (PPP) termination, while digital subscriber line (DSL) connections are terminated by multi-service switch 132.

Consumer/terminal node(s) 106 may include, but is not necessarily limited to, a multi-service switch 114, digital set-top boxes (DSTBs) 136, 138 and 140 and digital media adapters/televisions (DMA/TVs) 142, 144 and 146. In an embodiment, digital set-top boxes 136, 138 and 140 are Internet protocol (IP) digital set-top boxes. Multi-service switch 114 connects to SONET ring 110.

Each of digital set-top boxes 136, 138 and 140 is connected to one of digital media adapter/televisions 142, 144 and 146 (where each digital set-top box and digital media adapter/television pair creates one consumer/terminal node). For example, digital set-top box 136 distributes in-home video to digital media adapter/television 142, digital set-top box 138 distributes in-home media to digital media adapter/television 144, and so forth. Although three digital set-top boxes and three digital media adapters/televisions are shown in FIG. 1, it is understood that any number of digital set-top boxes and digital media adapters/televisions may be present (and thus any number of consumer/terminal nodes).

It is to be appreciated that a lesser or more equipped media distribution network 100 than the example described above may be preferred for certain implementations. Embodiments of the invention may also be applied to other types of software-driven systems that use different hardware architectures than that shown in FIG. 1.

FIG. 2 illustrates one embodiment of a fingerprint control protocol 200 in which one or more embodiments of the invention may utilize. In an embodiment of the invention, it is assumed that a MPEG-over-IP delivery file format is utilized. Referring to FIG. 2, fingerprint control protocol 200 may include, but is not necessarily limited to, the following fields: an Internet protocol (IP) header 202, a user datagram protocol (UDP) header 204, a real-time transport protocol (RTP) header 206, a FlexMux header 208, a synchronization layer (SL) header 210 and elementary stream (ES) data 212. In an embodiment of the invention, control logic and parameters are packaged as elementary stream data into a MPEG delivery file format, which itself is IP encapsulated (RTP/UDP/IP).

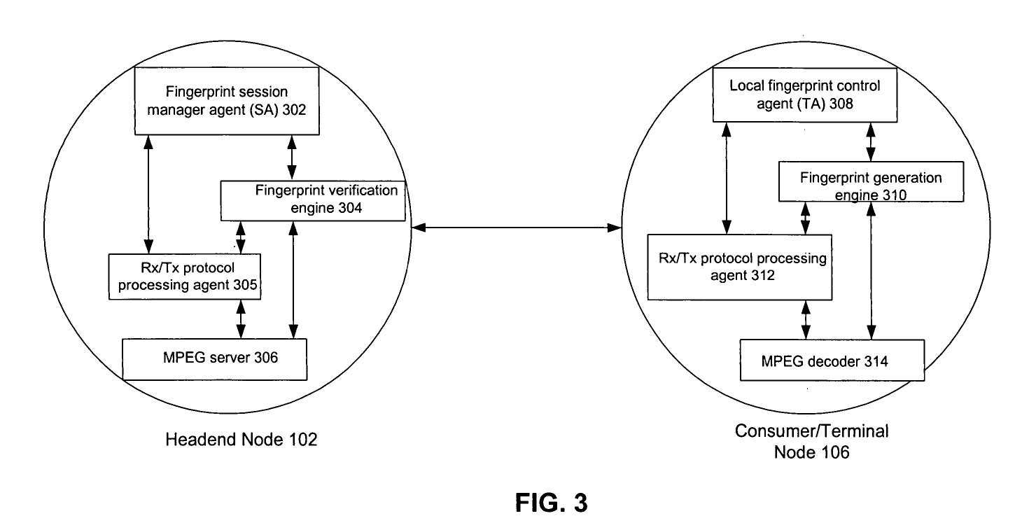

Fingerprint control protocol 200 is an application level control protocol used for realizing and managing fingerprint processing (i.e., generation and verification). Fingerprint generation includes, but is not necessarily limited to, using a technique to identify the content of the fingerprint. Fingerprint verification includes, but is not necessarily limited to, detecting context aware violations or degradations of the fingerprint. An embodiment of the inter-workings of fingerprint control protocol 200 are described next with reference to FIG. 3.

FIG. 3 illustrates an embodiment of the inter-workings of fingerprint control protocol 200. Referring to FIG. 3, headend node 102 (from FIG. 1) may include, but is not necessarily limited to, a fingerprint session manager agent (SA) 302, a fingerprint verification engine 304, a Rx/Tx protocol processing agent 305 and a MPEG server 306. The packetization of the fingerprint control protocol involves packing data into private MPEG elementary streams via Rx/Tx protocol processing agent 305 and MPEG server 306 so that it can be transported via the protocol over media distribution network 100 to consumer/terminal node(s) 106.

Consumer/terminal node(s) 106 (from FIG. 1) includes a local fingerprint control agent (TA) 308, a fingerprint generation engine 310, a Rx/Tx protocol processing agent 312 and a MPEG decoder 314. In an embodiment of the invention, each consumer/terminal node has its own TA 308.

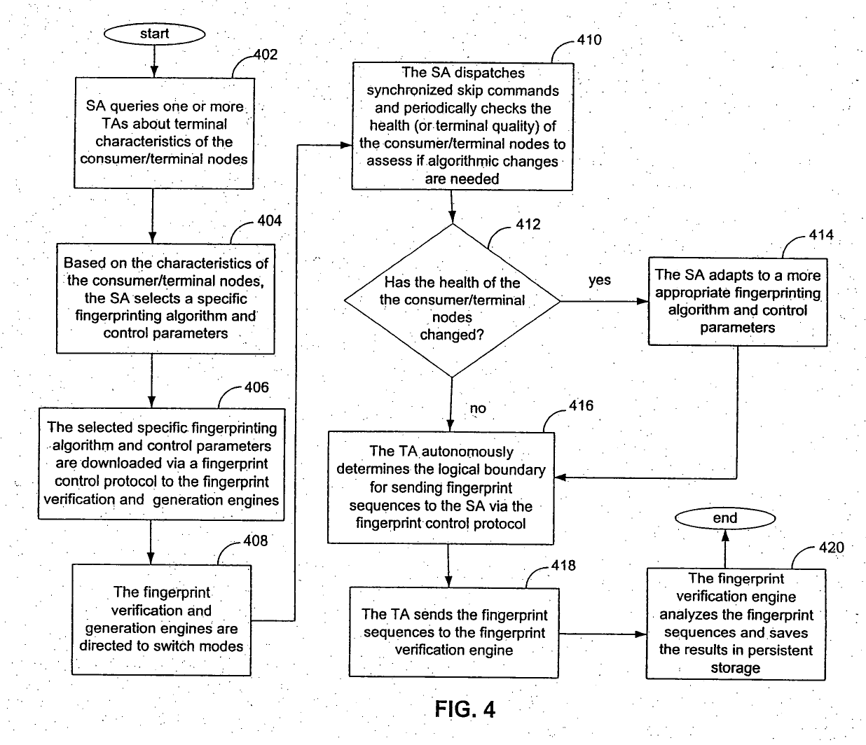

In an embodiment of the invention, each fingerprint control protocol session utilizes fingerprint verification engine 304 and fingerprint generation engine 310. SA 302 provides fingerprint verification engine 304 all of the necessary directives to operate. Likewise, TA 308 provides fingerprint generation engine 310 all of the necessary directives to operate. SA 302 and one or more TAs 308 communicate to allow remote configuration and adaptive fingerprint processing. An embodiment of the operation of the fingerprint control protocol is described next with reference to FIG. 4.

FIG. 4 is a flow diagram of one embodiment of a process for operating the fingerprint control protocol. Referring to FIG. 4, the process begins at processing block 402 where SA 302 queries one or more TAs 308 about terminal characteristics of the consumer/terminal node(s) 106.

At processing block 404, based on the characteristics of the consumer/terminal node(s) 106, SA 302 selects a specific fingerprinting algorithm and control parameters. At processing block 406, the selected fingerprinting algorithm and control parameters are downloaded via a fingerprint control protocol to fingerprint verification engine 304 and fingerprint generation engine 310.

At processing block 408, fingerprint verification engine 304 and fingerprint generation engine 310 are directed to switch modes (e.g., init->start). At processing block 410, SA 302 dispatches synchronized skip commands to periodically check the health (or terminal quality) of consumer/terminal node(s) 106 to assess if algorithmic changes are needed.

At decision block 412, it is determined whether the health of the consumer/terminal node(s) 106 has changed. If the outcome of decision block 412 is positive, then the process flows to processing block 414. Alternatively, the process flows directly to processing block 416. At processing block 414, SA 302 adapts to a more appropriate fingerprinting algorithm and control parameters.

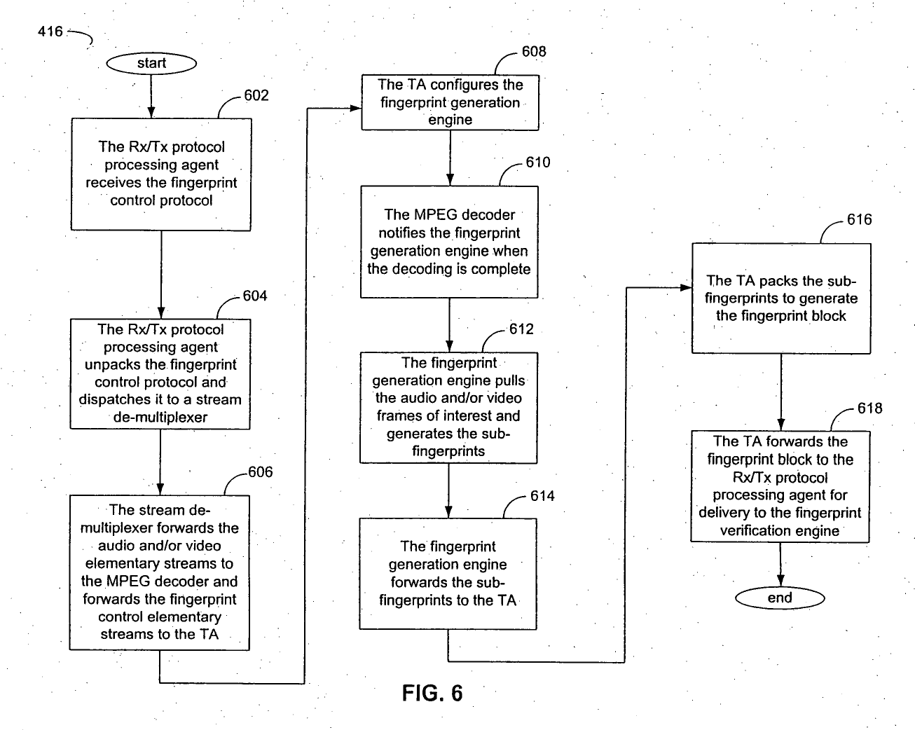

At processing block 416, TA 308 autonomously determines the logical boundary for sending fingerprint sequences to SA 302 via the fingerprint control protocol. The packetization of the finger control protocol involves packing data into private MPEG elementary streams via MPEG server 306 so that it can be transported via the protocol over media distribution network 100. Processing block 416 is described in more detail below with reference to FIG. 6.

At processing block 418, TA 308 sends the fingerprint sequences to fingerprint verification engine 304. At processing block 420, fingerprint verification engine 304 analyzes the fingerprint sequences (via Rx/Tx protocol processing agent 305) and saves the results in persistent storage. The process of FIG. 4 ends at this point.

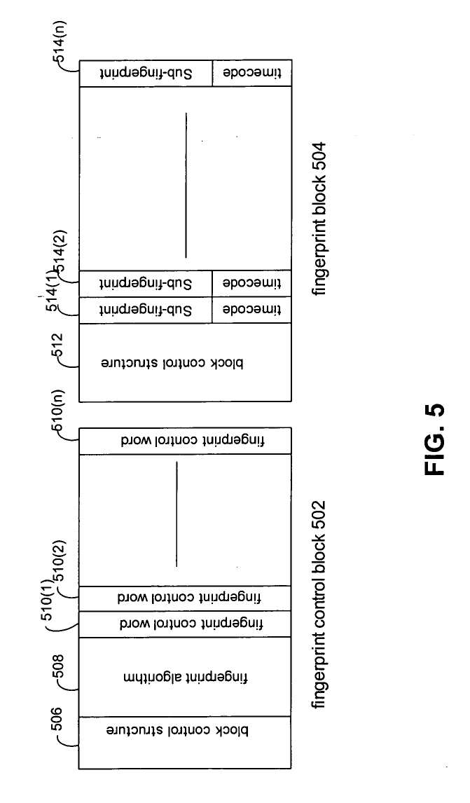

In an embodiment, fingerprint control blocks and fingerprint blocks are data structures utilized by the invention to store the fingerprinting algorithm to be deployed, to store various low level control words, etc. FIG. 5 illustrates an embodiment of a fingerprint control block 502 and a fingerprint block 504 in which some embodiments of the present invention may utilize. Fingerprint control block 502 may include, but is not necessarily limited to, the following fields: a block control structure 506, a fingerprint algorithm 508 and one or more fingerprint control words 510(1) through 510(n). In an embodiment, fingerprint control block 502 is encapsulated by the elementary stream.

Fingerprint block 504 may include, but is not necessarily limited to, the following fields: a block control structure 512 and one or more timecode/sub-fingerprints 514(1) through 514(n). Each sub-fingerprint in timecode/sub-fingerprints 514(1) through 514(n) corresponds to an audio or video frame. A chain of these sub-fingerprints constitute a fingerprint block. In an embodiment of the invention, the size of fingerprint block 504 is determined by TA 308 and is based on fingerprint control words 510(1) through 510(n) in fingerprint control block 502.

FIG. 6 is a flow diagram of one embodiment of a process for the operation of consumer/terminal node(s) 106 (step 416 of FIG. 4). Referring to FIG. 6, the process begins at processing block 602 where Rx/Tx protocol processing agent 312 receives the fingerprint control protocol. In processing block 604, Rx/Tx protocol processing agent 312 unpacks the fingerprint control protocol and dispatches it to a stream de-multiplexer. The stream de-multiplexer, in processing block 606, forwards the audio and/or video elementary streams to MPEG decoder 314 and also forwards the fingerprint control elementary streams to TA 308.

In processing block 608, TA 308 configures fingerprint generation engine 310. MPEG decoder 314, in processing block 610, notifies fingerprint generation engine 310 when the decoding is complete. In processing block 612, fingerprint generation engine 310 pulls the audio and/or video frames of interest and generates the sub-fingerprints.

In processing block 614, fingerprint generation engine 310 forwards the sub-fingerprints to TA 308. In processing block 616, TA 308 packs the sub-fingerprints to generate fingerprint block 504. TA 308, in processing block 618, forwards fingerprint block 504 to Rx/Tx protocol processing agent 312 for delivery to fingerprint verification engine 304. The process of FIG. 6 ends at this point.

In an embodiment of the invention, TA 308 and fingerprint generation engine 310 may be used to control the processing of MPEG decoder 314.

A system and method for controlling fingerprint processing in a media network via an efficient protocol have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method, comprising:
determining, at a headend node, terminal node characteristics of a media network;
based on the determined terminal node characteristics, selecting an algorithm and one or more control parameters for processing a fingerprint;
downloading the selected algorithm and one or more control parameters to a fingerprint control protocol; and
transferring the fingerprint control protocol to a terminal node.

2. The method of claim 1, further comprising:
utilizing, at the terminal node, the fingerprint control protocol to process the fingerprint.

3. The method of claim 2, wherein utilizing, at the terminal node, the fingerprint control protocol to process the fingerprint, comprises:
generating the fingerprint; and
forwarding the fingerprint to the headend node for verification.

4. The method of claim 1, further comprising:
periodically checking the terminal node characteristics to adjust the selected algorithm and one or more control parameters.

5. The method of claim 1, wherein the fingerprint control protocol includes data that is packed into one or more MPEG elementary streams.

6. The method of claim 1, wherein the fingerprint is a video fingerprint.

7. The method of claim 1, wherein the fingerprint is an audio fingerprint.

8. The method of claim 1, wherein the fingerprint control protocol is an application level control protocol.

9. A system, comprising:
a headend node, wherein the headend node determines terminal node characteristics of a media network, wherein the headend node selects an algorithm and one or more control parameters to process a fingerprint based on the determined terminal node characteristics, and wherein the headend node downloads the selected algorithm and control parameters to a fingerprint control protocol.

10. The system of claim 9, further comprising:
a terminal node, wherein the terminal node receives the fingerprint control protocol from the headend node and uses the fingerprint control protocol to process the fingerprint.

11. The system of claim 10, wherein the terminal node generates the fingerprint and forwards the fingerprint to the headend node for verification.

12. The system of claim 9, wherein the headend node periodically checks the terminal node characteristics to adjust the selected algorithm and one or more control parameters.

13. The system of claim 9, wherein the fingerprint control protocol includes data that is packed into one or more MPEG elementary streams.

14. The system of claim 9, wherein the fingerprint is a video fingerprint.

15. The system of claim 9, wherein the fingerprint is an audio fingerprint.

16. The system of claim 9, wherein the fingerprint control protocol is an application level control protocol.

17. A machine-readable medium containing instructions which, when executed by a processing system, cause the processing system to perform a method, the method comprising:
determining, at a headend node, terminal node characteristics of a media network;
based on the determined terminal node characteristics, selecting an algorithm and one or more control parameters for processing a fingerprint;
downloading the selected algorithm and one or more control parameters to a fingerprint control protocol; and
transferring the fingerprint control protocol to a terminal node.

18. The machine-readable medium of claim 17, further comprising:
utilizing, at the terminal node, the fingerprint control protocol to process the fingerprint.

19. The machine-readable medium of claim 18, wherein utilizing, at the terminal node, the fingerprint control protocol to process the fingerprint, comprises:
generating the fingerprint; and
forwarding the fingerprint to the headend node for verification.

20. The machine-readable medium of claim 17, further comprising:
periodically checking the terminal node characteristics to adjust the selected algorithm and one or more control parameters.

21. The machine-readable medium of claim 17, wherein the fingerprint control protocol includes data that is packed into one or more MPEG elementary streams.

22. The machine-readable medium of claim 17, wherein the fingerprint is a video fingerprint.

23. The machine-readable medium of claim 17, wherein the fingerprint is an audio fingerprint.

24. The machine-readable medium of claim 17, wherein the fingerprint control protocol is an application level control protocol.
